(19) United States
(12) Patent Application Publication
(10) Pub. No.: US 2012/0156369 A1
(43) Pub. Date: Jun. 21, 2012

(54) METHOD OF FORMING OPTICAL COUPLER

(75) Inventors: In Gyoo KIM, Daejeon (KR); Sang Hoon KIM, Seoul (KR); Gyungock KIM, Daejeon (KR)

(73) Assignee: Electronics and Telecommunications Research Institute, Daejeon (KR)

(21) Appl. No.: 13/289,743

(22) Filed: Nov. 4, 2011

(30) Foreign Application Priority Data
Dec. 16, 2010 (KR) 10-2010-0129144

(51) Int. Cl. G02B 6/26

(52) U.S. Cl. 427/163.2

(57) ABSTRACT

Provided are methods of forming an optical coupler. The method includes forming a first waveguide and an in-plane tapered layer on a silicon layer, forming a mask with first and second openings. The first opening is formed between the in-plane tapered layer and the second opening, and the second opening extends from the first opening with a gradually narrowing width. Thereafter, a planar waveguide and a three-dimensional tapered layer are simultaneously formed in the first and second openings, respectively. The planar waveguide has a substantially uniform thickness, and the three-dimensional tapered layer has a thickness gradually increasing with a decrease of the width thereof.

### CROSS-REFERENCE TO RELATED APPLICATIONS

This U.S. non-provisional patent application claims priority under 35 U.S.C.§119 to Korean Patent Application No. 10-2010-0129144, filed on Dec. 16, 2010, in the Korean Intellectual Property Office, the entire contents of which are hereby incorporated by reference.

### BACKGROUND OF THE INVENTION

Embodiments of the inventive concepts relate generally to methods of forming an optical coupler. More particularly, embodiments of the inventive concepts relate to methods of forming a silicon optical coupler.

As the semiconductor industry becomes more and more advanced, increasing are demands for semiconductor integrated circuits with light weight, high density and high speed. However, owing to a variety of reasons, it is not easy to satisfy this demand. For example, since transmission of electric signal via a conductive wire is based on movement of electronic charges with finite mass, it may lead to technical difficulties, such as heating and/or limited communication speed. In other words, the transmission of electric signal via a conductive wire may have a limitation in realizing effective intra- or inter-IC communication.

Optical communication or optical interconnection technology is being extensively studied to overcome these difficulties. In the optical communication or interconnection, optical signals can be transmitted among electric or electronic components (e.g., ICs, electric components in IC, and so forth) via an optical waveguide. Accordingly, the optical waveguide should be optimized to minimize optical loss.

### SUMMARY

Embodiments of the inventive concepts provide methods of forming an optical coupler having improved optical coupling efficiency.

According to example embodiments of the inventive concepts, a method of forming an optical coupler may include forming a first waveguide and an in-plane tapered layer on a silicon layer, forming a mask with first and second openings. The first opening is formed between the in-plane tapered layer and the second opening, and the second opening extends from the first opening with a gradually narrowing width. Thereafter, a planar waveguide and a three-dimensional tapered layer are simultaneously formed in the first and second openings, respectively. The planar waveguide has a substantially uniform thickness, and the three-dimensional tapered layer has a thickness gradually increasing with a decrease of the width thereof

In some embodiments, the planar waveguide and the three-dimensional tapered layer may be formed using a selective epitaxial growth.

In some embodiments, the planar waveguide may be formed to have the substantially same thickness as the in-plane tapered layer.

In some embodiments, the forming of the planar waveguide and the three-dimensional tapered layer may be performed to form a second waveguide being contact with a sidewall of the three-dimensional tapered layer, the three-dimensional tapered layer being interposed between the planar waveguide and the second waveguide.

In some embodiments, the method may further include disposing an optical fiber aligned with the second waveguide.

In some embodiments, the mask may be formed to further have a third opening with a substantially uniform width, the second opening extending from a sidewall of the second opening facing the first opening.

In some embodiments, the method may further include forming a substrate and a buried oxide disposed under the silicon layer. The substrate, the buried oxide, and the silicon layer may constitute a silicon-on-insulator substrate.

In some embodiments, the first waveguide and the in-plane tapered layer may be formed by patterning an upper portion of the silicon layer.

In some embodiments, the method may further include reducing widths of the in-plane tapered layer, the planar waveguide, and the three-dimensional tapered layer to form an in-plane tapered fine layer and a three-dimensional tapered fine layer.

In some embodiments, the method may further include forming an optical device disposed around the second opening and on the silicon layer in such a way that the optical device is formed to be in contact with the three-dimensional tapered layer.

### BRIEF DESCRIPTION OF THE DRAWINGS

Example embodiments will be more clearly understood from the following brief description taken in conjunction with the accompanying drawings. FIGS. 1-12 represent non-limiting, example embodiments as described herein.

FIGS. 1 through 5 show exemplarily a method of forming an optical coupler according to example embodiments of the inventive concepts;

FIGS. 6 through 8 show exemplarily a method of forming an optical coupler according to other example embodiments of the inventive concepts;

FIG. 9 shows exemplarily a method of forming an optical coupler according to modified embodiments of the inventive concepts; and

FIGS. 10 through 12 show exemplarily a method of forming an optical coupler according to other modified embodiments of the inventive concepts.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify, the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

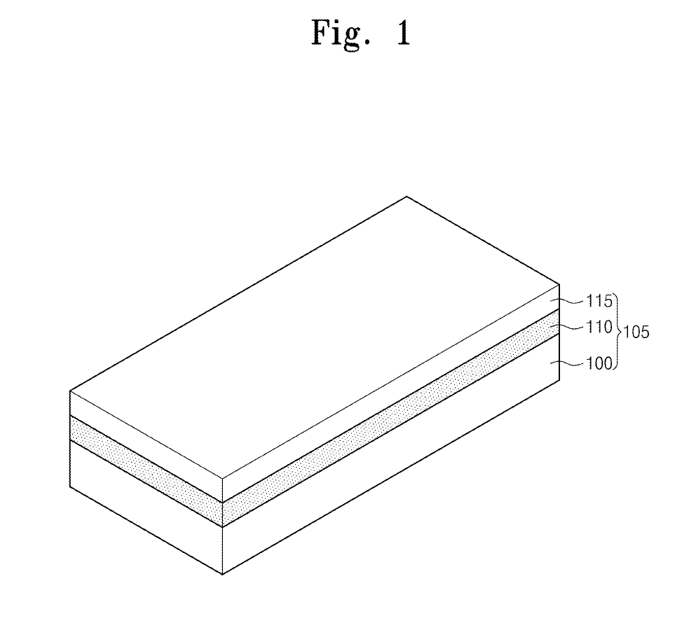

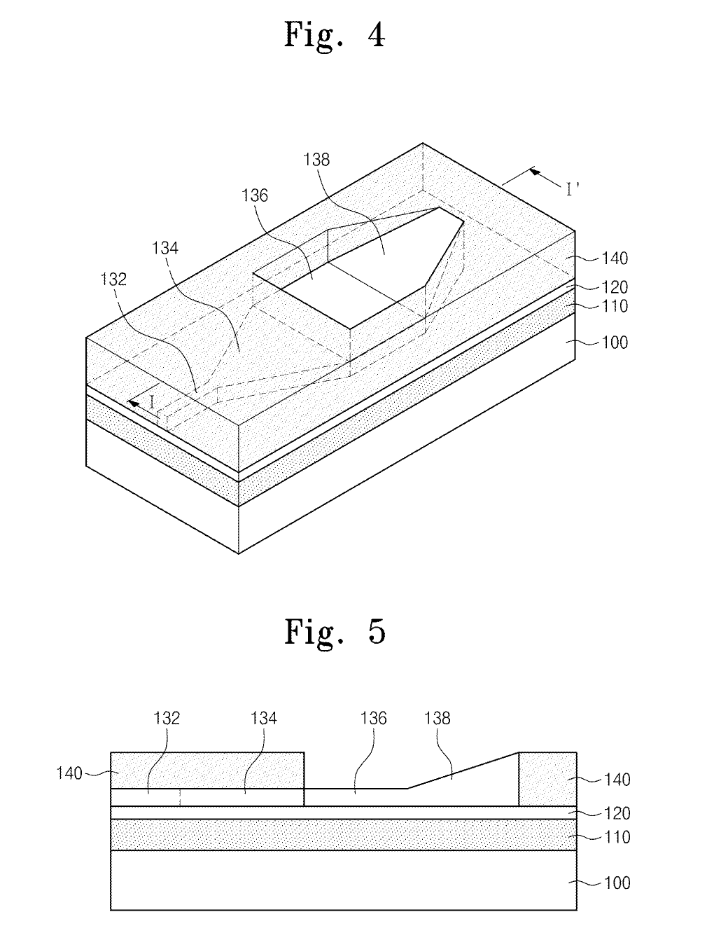

FIGS. 1 through 4 are perspective views illustrating a method of forming an optical coupler according to example embodiments of the inventive concepts. FIG. 5 is a sectional view taken along a line I-I′ of FIG. 4.

Referring to FIG. 1, a silicon-on-insulator (SOI) substrate 105 may be provided. The SOI substrate 105 may include a substrate 100, a buried oxide 110 and a preliminary silicon layer 115.

The preliminary silicon layer 115 may be formed of a material having a different refractive index from that of the buried oxide 110. This difference in refractive index may be used to realize an active optical device, such as, a silicon optical waveguide, a modulator, an optical detector, or a ring-filter, and/or a passive optical device on the SOI substrate 105. For instance, silicon photonics technology is advantageous in fabricating a silicon-based optical device of high performance, because silicon is an inexpensive material and can be provided with a large area. In addition, the silicon photonics technology is advantageous in monolithically integrating an integrated circuit (IC), such as a driver and an amplifying circuit, along with the optical device.

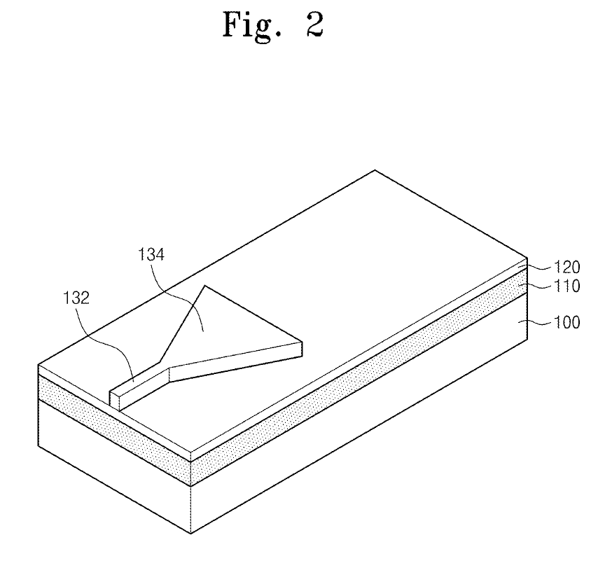

Referring to FIG. 2, an upper portion of the preliminary silicon layer 115 may be patterned to form a first waveguide 132 and an in-plane tapered layer 134. The formation of the first waveguide 132 and the in-plane tapered layer 134 may include forming a mask pattern (not shown) on the preliminary silicon layer 115 and then etching the preliminary silicon layer 115 using the mask pattern as an etch mask. After the patterning process, a lower portion of the preliminary silicon layer 115 (hereinafter, a silicon layer 120) may remain under the first waveguide 132 and the in-plane tapered layer 134.

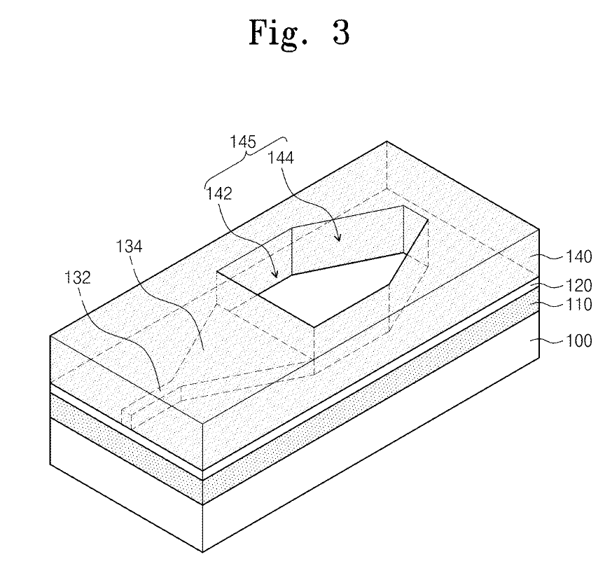

Referring to FIG. 3, a mask 140 may be formed to have an opening 145 exposing the silicon layer 120. The opening 145 may include a first opening 142 having a uniform width and a second opening 144 extending from the first opening 142 with a gradually narrowing width. In some embodiments, the mask 140 may cover the first waveguide 132 and the in-plane tapered layer 134. For instance, the first opening 142 may have a sidewall aligned with that of the in-plane tapered layer 134 in such a way that sidewalls of the first opening 142 and the in-plane tapered layer 134 are coplanar with each other. In some embodiments, the mask 140 may be formed of silicon oxide.

Referring to FIGS. 4 and 5, a planar waveguide 136 and a three-dimensional tapered layer 138 may be formed in the opening 145. In some embodiments, the planar waveguide 136 and the three-dimensional tapered layer 138 may be formed by a selective epitaxial growth technique using the silicon layer 120 exposed by the opening 145 as a seed layer. The planar waveguide 136 and the three-dimensional tapered layer 138 may be simultaneously grown by using the same process. In some embodiments, the difference in width between the first and second openings 142 and 144 may result in a difference in thickness between the planar waveguide 136 and the three-dimensional tapered layer 138. This is because the growth rate of silicon may be higher in the narrow second opening 144 than in the wide first opening 142. In this case, since the second opening 144 is formed to have the gradually narrowing width as shown in FIG. 3, the three-dimensional tapered layer 138 may be formed to have a shape tapered in both of horizontal and vertical directions. The mask 140 may be formed to a thickness sufficient to prevent an unintended growth of silicon outside the opening 145.

The selective epitaxial growth may be performed using a reduced pressure chemical vapor deposition or a low pressure chemical vapor deposition. In some embodiments, during the selective epitaxial growth, a hydrogen chloride (HCl) gas and a dichlorosilane (SiCl₂H₂; DCS) gas may be supplied on the resultant structure provided with the mask 140, along with a hydrogen gas as a carrier gas. A mass flow controller may be used to control flow rates of the gases.

In some embodiments, the thickest portion of the three-dimensional tapered layer 138 may have a thickness about five times greater than a thickness of the planar waveguide 136, but example embodiments of the inventive concepts may not be limited thereto. For instance, depending on shape and/or structure of the mask 140, the three-dimensional tapered layer 138 or the planar waveguide 136 may vary in terms of thickness dispersion and/or thickness increasing factor. In some embodiments, the planar waveguide 136 and the three-dimensional tapered layer 138 may be formed by using a plurality of selective epitaxial growth steps, and moreover, at least one of the selective epitaxial growth steps may be performed using a different mask from the others in terms of shape and/or thickness. Thereafter, at least a portion of the mask 140 may be removed to expose a facet of the three-dimensional tapered layer 138 covered with the mask 140. The exposed facet of the three-dimensional tapered layer 138 may be optically connected to an external optical fiber. As a result, there is no necessity for polishing the three-dimensional tapered layer 138 additionally so as to make the face connected to the external optical fiber.

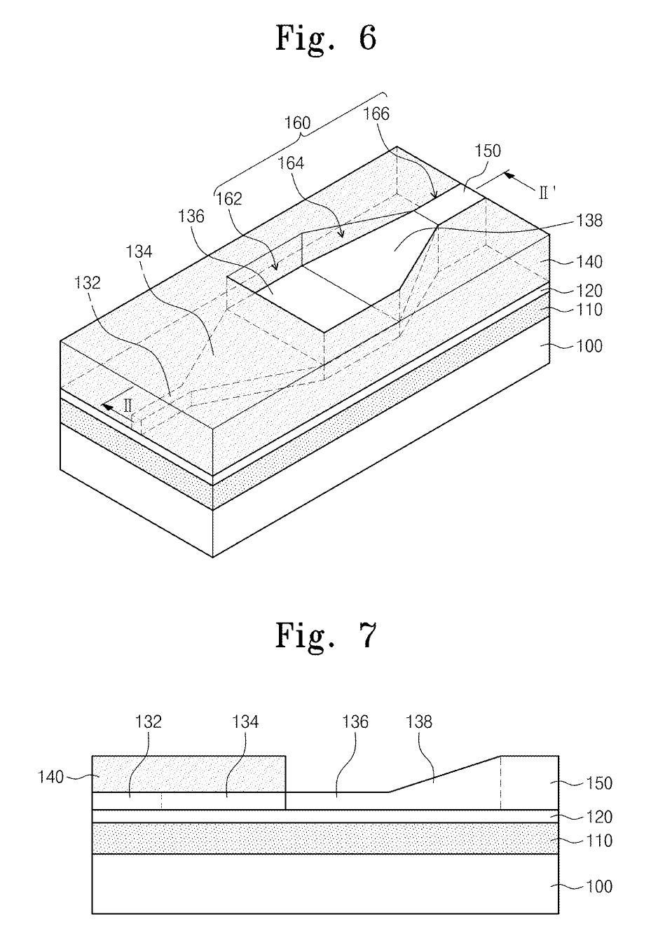

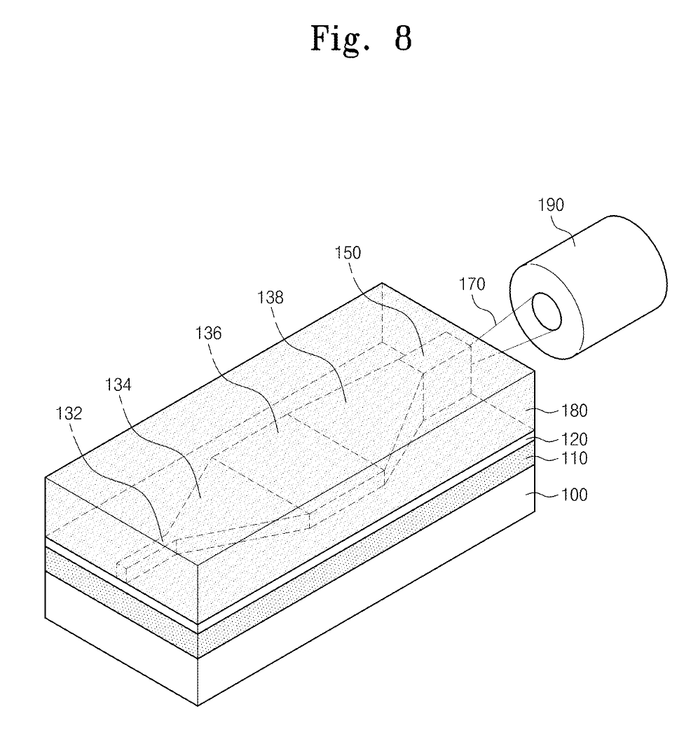

FIGS. 6 and 8 are perspective views illustrating a method of forming an optical coupler according to other example embodiments of the inventive concepts. FIG. 7 is a sectional view taken along a line II-II′ of FIG. 6. For concise description, overlapping description of elements previously described with reference to FIGS. 1 through 5 may be omitted.

Referring to FIGS. 6 through 8, an SOI substrate including a substrate 100, a buried oxide 110 and a preliminary silicon layer may be provided. An upper portion of the preliminary silicon layer may be patterned to form a first waveguide 132 and an in-plane tapered layer 134. After the patterning process, a lower portion of the preliminary silicon layer (hereinafter, a silicon layer 120) may remain under the first waveguide 132 and the in-plane tapered layer 134.

A mask 140 may be formed to have an opening 160 exposing the silicon layer 120. The opening 160 may include a first opening 162 having a uniform width, a second opening 164 extending from the first opening 162 with a gradually narrowing width, and a third opening 166 extending from the second opening 164 with a uniform width. In some embodiments, the mask 140 may cover the first waveguide 132 and the in-plane tapered layer 134. For instance, the first opening 162 may have a sidewall aligned with that of the in-plane tapered layer 134 in such a way that sidewalls of the first opening 162 and the in-plane tapered layer 134 are coplanar with each other. In some embodiments, the mask 140 may be formed of silicon oxide.

A planar waveguide 136 and a three-dimensional tapered layer 138 may be formed in the opening 160. In some embodiments, the planar waveguide 136 and the three-dimensional tapered layer 138 may be formed by a selective epitaxial growth technique using the silicon layer 120 exposed by the opening 160 as a seed layer. The planar waveguide 136 and the three-dimensional tapered layer 138 may be simultaneously grown by using the same process. In some embodiments, the difference in width between the first and second openings 162 and 164 may result in a difference in thickness between the planar waveguide 136 and the three-dimensional tapered layer 138. This is because the growth rate of silicon may be higher in the narrow second opening 164 than in the wide first opening 162.

In the meantime, a second waveguide 150 may be formed in the third opening 166. The second waveguide 150 may be formed by a selective epitaxial growth technique using the silicon layer 120 exposed by the third opening 166. The second waveguide 150 may be formed to be greater in thickness and width than the first waveguide 132. For instance, the thickest portion of the second waveguide 150 may have the substantially same thickness as that of the three-dimensional tapered layer 138. In some embodiments, the planar waveguide 136, the three-dimensional tapered layer 138 and second waveguide 150 may be simultaneously formed using the same selective epitaxial growth process.

Referring to FIG. 8, the mask 140 may be removed and then a cladding layer 180 may be formed to cover the first waveguide 132, the in-plane tapered layer 134, the planar waveguide 136, the three-dimensional tapered layer 138, and the second waveguide 150. The cladding layer 180 may be formed of a material having a refractive index smaller than that of silicon. An optical fiber 190 may be aligned to the second waveguide 150. According to example embodiments of the inventive concepts, an optical signal incident to the first waveguide 132 may be transmitted to the optical fiber 190 via the in-plane tapered layer 134, planar waveguide 136, the three-dimensional tapered layer 138 and the second waveguide 150. Also, an optical signal incident to the second waveguide 150 from the optical fiber 190 may be transmitted to the first waveguide 132. The optical fiber 190 may be a lensed thermally expanded core optical fiber. A size of the second waveguide 150 may be configured so that the second waveguide 150 can be optically connected to the optical fiber 190 in the mode-matching manner. In some embodiments, the optical coupler may be configured to transmit an optical signal adiabatically.

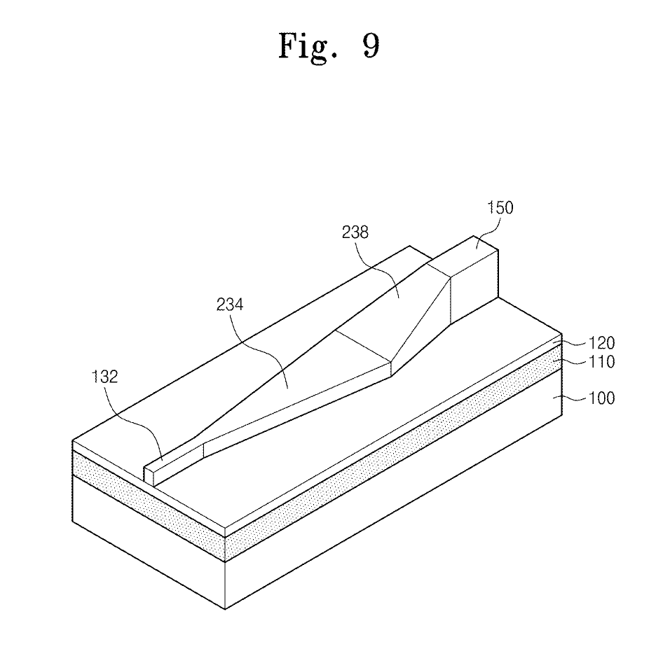

FIG. 9 is a perspective view illustrating a method of forming an optical coupler according to modified embodiments of the inventive concepts.

Referring back to FIG. 6, an SOI substrate including a substrate 100, a buried oxide 110 and a preliminary silicon layer may be provided. An upper portion of the preliminary silicon layer may be patterned to form a first waveguide 132 and an in-plane tapered layer 134. After the patterning process, a lower portion of the preliminary silicon layer (hereinafter, a silicon layer 120) may remain under the first waveguide 132 and the in-plane tapered layer 134. A planar waveguide 136, a three-dimensional tapered layer 138, and a second waveguide 150 may be formed by a selective epitaxial growth technique using the silicon layer 120 as a seed layer, as described with reference to FIG. 6.

Referring to FIG. 9, the in-plane tapered layer 134, planar waveguide 136 and the three-dimensional tapered layer 138 may be patterned to form an in-plane tapered fine layer 234 and a three-dimensional tapered fine layer 238. The formation of the in-plane tapered fine layer 234 and the three-dimensional tapered fine layer 238 may be performed to reduce widths of the in-plane tapered layer 134, planar waveguide 136, and the three-dimensional tapered layer 138. The first waveguide 132 may be optically connected to an active and/or passive device, such as an optical modulator, an optical detector, an optical filter.

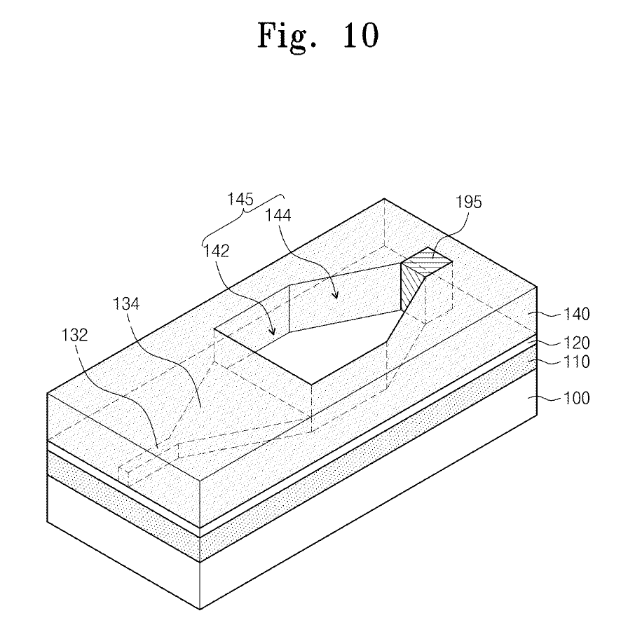

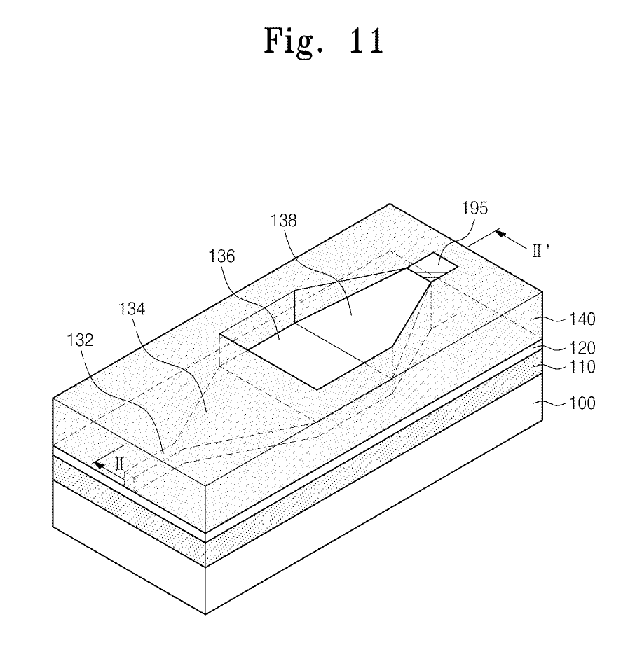

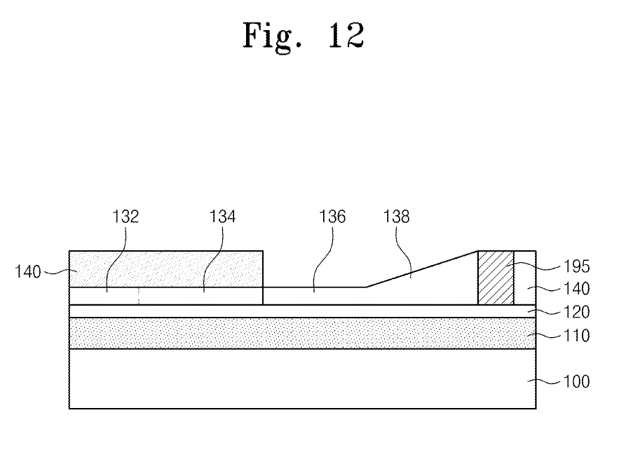

FIGS. 10 and 11 are perspective views illustrating a method of forming an optical coupler according to other modified embodiments of the inventive concepts. FIG. 12 is a sectional view taken along a line II-II′ of FIG. 11. For concise description, overlapping description of elements previously described with reference to FIGS. 1 through 9 may be omitted.

Referring to FIG. 10, an SOI substrate including a substrate 100, a buried oxide 110 and a preliminary silicon layer may be provided. An upper portion of the preliminary silicon layer may be patterned to form a first waveguide 132 and an in-plane tapered layer 134. After the patterning process, a lower portion of the preliminary silicon layer (hereinafter, a silicon layer 120) may remain under the first waveguide 132 and the in-plane tapered layer 134.

An optical device 195 may be integrated on the silicon layer 120. In some embodiments, the optical device 195 may be an optical detector. For instance, the optical detector may be a germanium optical detector. A mask 140 may be formed to have an opening 145 exposing the silicon layer 120. The opening 145 may include a first opening 142 having a uniform width and a second opening 144 extending from the first opening 142 with a gradually narrowing width. In some embodiments, the mask 140 may cover the first waveguide 132 and the in-plane tapered layer 134. For instance, the first opening 142 may have a sidewall aligned with that of the in-plane tapered layer 134 in such a way that sidewalls of the first opening 142 and the in-plane tapered layer 134 are coplanar with each other. In some embodiments, a sidewall of the second opening 144 may be formed in such a way that it is coplanar with a sidewall of the optical device 195.

Referring to FIGS. 11 and 12, a planar waveguide 136 and a three-dimensional tapered layer 138 may be formed in the opening 145. In some embodiments, the planar waveguide 136 and the three-dimensional tapered layer 138 may be formed by a selective epitaxial growth technique using the silicon layer 120 exposed by the opening 145 as a seed layer. The planar waveguide 136 and the three-dimensional tapered layer 138 may be simultaneously grown by using the same process. In some embodiments, the three-dimensional tapered layer 138 may be formed to be in contact with the optical device 195. By virtue of the optical device 195 integrated on the silicon layer 120, the first waveguide 132 and the optical device 195 can exhibit good optical response.

According to example embodiments of the inventive concepts, a size, shape and/or structure of an optical waveguide in an optical coupler may be controlled by a selective epitaxial growth, and this enables to improve optical coupling efficiency. Furthermore, by virtue of the use of the selective epitaxial growth, the optical coupler can be fabricated in a CMOS compatible and reproducible manner.

While example embodiments of the inventive concepts have been particularly shown and described, it will be understood by one of ordinary skill in the art that variations in form and detail may be made therein without departing from the spirit and scope of the at t ached claims.

What is claimed is:

1. A method of forming an optical coupler, comprising:
forming a first waveguide and an in-plane tapered layer on a silicon layer;
forming a mask with first and second openings, the first opening being formed between the in-plane tapered layer and the second opening and the second opening extending from the first opening with a gradually narrowing width; and
simultaneously forming a planar waveguide and a three-dimensional tapered layer in the first and second openings, respectively, the planar waveguide having a substantially uniform thickness and the three-dimensional tapered layer having a thickness gradually increasing with a decrease of the width thereof.

2. The method of claim 1, wherein the planar waveguide and the three-dimensional tapered layer are formed using a selective epitaxial growth.

3. The method of claim 2, wherein the planar waveguide is formed to have the substantially same thickness as the in-plane tapered layer.

4. The method of claim 2, wherein the forming of the planar waveguide and the three-dimensional tapered layer is performed to form a second waveguide being contact with a sidewall of the three-dimensional tapered layer, the three-dimensional tapered layer being interposed between the planar waveguide and the second waveguide.

5. The method of claim 4, further comprising disposing an optical fiber aligned with the second waveguide.

6. The method of claim 4, wherein the mask is formed to further have a third opening with a substantially uniform width, the second opening extending from a sidewall of the second opening facing the first opening.

7. The method of claim 1, further comprising forming a substrate and a buried oxide disposed under the silicon layer, wherein the substrate, the buried oxide, and the silicon layer constitute a silicon-on-insulator substrate.

8. The method of claim 7, wherein the first waveguide and the in-plane tapered layer are formed by patterning an upper portion of the silicon layer.

9. The method of claim 1, further comprising reducing widths of the in-plane tapered layer, the planar waveguide, and the three-dimensional tapered layer to form an in-plane tapered fine layer and a three-dimensional tapered fine layer.

10. The method of claim 1, further comprising forming an optical device disposed around the second opening and on the silicon layer, wherein the optical device is formed to be in contact with the three-dimensional tapered layer.
